(19) United States
(12) Patent Application Publication
(10) Pub. No.: US 2016/0164287 A1
(43) Pub. Date: Jun. 9, 2016

(54) BI-DIRECTIONAL COMMUNICATIONS ON AN ELECTRICAL SECONDARY NETWORKED DISTRIBUTION SYSTEM

(71) Applicant: Lockheed Martin Corporation, Bethesda, MD (US)

(72) Inventor: Henrik F. Bernheim, Denver, CO (US)

(21) Appl. No.: 14/958,385

(22) Filed: Dec. 3, 2015

Related U.S. Application Data
(60) Provisional application No. 62/086,980, filed on Dec. 3, 2014.

(51) Int. Cl. H02J 3/00; G05B 15/02

(52) U.S. Cl. CPC H02J 3/00; G05B 15/02

(57) ABSTRACT

Mechanisms for bi-directional communications on an electrical secondary networked distribution system are disclosed. A first edge node control device (ENCD) receives, via an off-grid communications interface, a message. The first ENCD is communicatively coupled to the secondary networked distribution system, and the secondary networked distribution system provides electricity to a plurality of consuming endpoints. The method further includes retransmitting, in response to receipt of the message, by the first ENCD on the secondary networked distribution system, the message to a plurality of internal node control devices communicatively coupled to the secondary networked distribution system at a plurality of locations.

### RELATED APPLICATIONS

This application claims the benefit of provisional patent application No. 62/086,980, filed on Dec. 3, 2014, entitled “SYSTEM AND METHOD FOR SECONDARY GRID COMMUNICATIONS,” the disclosure of which is hereby incorporated herein by reference in its entirety.

### TECHNICAL FIELD

The embodiments relate generally to electrical distribution systems and, in particular, to bi-directional communications on an electrical secondary networked distribution system.

### BACKGROUND

Electrical power is typically delivered over transmission lines to one or more primary distribution systems. The voltage on a primary distribution system is lower than the voltage on the transmission lines. For example, the voltage on the transmission lines may be between 138 kiloVolts (kV) and 765 kV, and the voltage on the primary distribution system may be between about 2 kV and 35 kV. The primary distribution system delivers the electrical power to one or more secondary distribution systems. The secondary distribution systems are at a lower voltage than the primary distribution system. For example, the voltage on a secondary distribution system may be below about 2 kV. Some customers that require substantial amounts of power may be coupled directly to the primary distribution systems. However, the vast majority of customers, both residential and commercial, are coupled to a secondary distribution system.

There are different types of secondary distribution systems, including, for example, a secondary radial distribution system and a secondary networked distribution system. A networked distribution system is more costly than a radial distribution system but offers high reliability because multiple feeders from the primary distribution system provide redundant electrical power to each consumer on the secondary networked distribution system. If one feeder goes down, the consumers continue to receive power provided by the other feeder. In dense urban metropolitan areas, secondary networked distribution systems are commonly used so that large numbers of consumers are not negatively impacted should a feeder go down.

In a secondary networked distribution system there are a number of locations, referred to herein as grid nodes (or “nodes”), where electrical control or monitoring (ECOM) devices, such as protection devices, switch devices, and electrical transformation devices, provide needed functionality to the secondary networked distribution system. In some areas, there may be a substantial number of such ECOM devices, and some or all of such ECOM devices may be housed in respective underground vaults. It is common that the ECOM devices are not coupled to communications lines, such as copper or fiber lines, via which the ECOM devices could communicate with other devices outside of the vault.

However, it often would be desirable to implement bi-directional communications with the ECOM devices to monitor and control the ECOM devices without requiring a human to go to a location of the equipment and enter an underground vault. Moreover, it may be desirable to control one or more of the ECOM devices located at different locations substantially concurrently, or in a predefined sequence. However, running communications lines to the ECOM devices may be prohibitively expensive, and wireless communications with ECOM devices in underground vaults may be impossible. While some mechanisms exist for communicating with the ECOM devices from the primary distribution system to the secondary distribution system, such mechanisms are relatively costly and often require the installation of additional equipment at the transformers. Moreover, signals on underground power lines bleed off much more rapidly than overhead lines, greatly reducing signal range.

### SUMMARY

The embodiments relate to bi-directional communications on an electrical secondary networked distribution system. The embodiments facilitate communications between an edge node control device coupled to a secondary networked distribution system and a plurality of internal node control devices coupled to the secondary networked distribution system. The internal node control devices may be coupled to the secondary networked distribution system at locations where electrical control or monitoring is located. The edge node control device receives a message from an off-grid interface and, based on the message, communicates an instruction over the secondary networked distribution system to one or more internal node control devices.

Among other advantages, the embodiments facilitate bi-directional communications without a need for relatively expensive equipment that is capable of communicating from high voltage lines to low voltage lines through a transformer, or communicating from low voltage lines to high voltage lines through a transformer, because all communications can occur within the secondary networked distribution system.

In one embodiment, a method for communicating on a secondary networked distribution system is provided. The method includes receiving, by a first edge node control device (ENCD) via an off-grid communications interface, a message. The first ENCD is communicatively coupled to the secondary networked distribution system, and the secondary networked distribution system provides electricity to a plurality of consuming endpoints. The method further includes retransmitting, in response to receiving the message, by the first ENCD on the secondary networked distribution system, the message to a plurality of internal node control devices communicatively coupled to the secondary networked distribution system at a plurality of locations.

In one embodiment, the first ENCD is located at a grid node, and the grid node houses an electrical control or monitoring (ECOM) device coupled to the secondary networked distribution system. The first ENCD is communicatively coupled to the ECOM device and is configured to, in response to receiving the first message, send a signal to the ECOM device to cause the ECOM device to alter or monitor an electrical characteristic of the secondary networked distribution system.

In one embodiment, the ECOM device comprises one of a transformer, a switch, a fuse, or a monitoring device.

In one embodiment, a plurality of ENCDs receive the message substantially concurrently, and the plurality of ENCDs retransmit, on the secondary networked distribution system, the message to the plurality of internal node control devices communicatively coupled to the secondary networked distribution system at the plurality of locations.

In one embodiment, the method further includes determining that the plurality of internal node control devices received the message.

In another embodiment, a system for communicating on a secondary networked distribution system is provided. The system includes an edge node control device that comprises an on-grid communications interface configured to be communicatively coupled to the secondary networked distribution system. The secondary networked distribution system is configured to provide electricity to a plurality of consuming endpoints. The edge node control device further includes an off-grid communications interface configured to communicate via an off-grid communications technology. A processing device is communicatively coupled to the on grid-communications interface and the off-grid communications interface, and is configured to receive, via the off-grid communications interface, a message. The processing device is further configured to, in response to receiving the message, retransmit on the secondary networked distribution system the message to a plurality of internal node control devices communicatively coupled to the secondary networked distribution system at a plurality of locations.

Those skilled in the art will appreciate the scope of the disclosure and realize additional aspects thereof after reading the following detailed description of the embodiments in association with the accompanying drawing figures.

### BRIEF DESCRIPTION OF THE DRAWINGS

The accompanying drawing figures incorporated in and forming a part of this specification illustrate several aspects of the disclosure and, together with the description, serve to explain the principles of the disclosure.

FIG. 1 is a block diagram of a system in which embodiments may be practiced;

FIG. 2 is a flowchart illustrating a method for communicating on a secondary networked distribution system according to one embodiment;

FIG. 3 is a block diagram illustrating a message layout of a message according to one embodiment.

FIGS. 4A-4B are block diagrams illustrating a communication of messages on a secondary networked distribution system according to one embodiment;

FIGS. 5A-5C are block diagrams illustrating a store-and-forward communication of messages on a secondary networked distribution system according to another embodiment;

FIG. 6 is a block diagram illustrating a mechanism for determining that edge node control devices (ENCDs) and internal node control devices (INCDs) have received a message according to one embodiment;

FIGS. 7A-7B are block diagrams illustrating a mechanism for determining that ENCDs and INCDs have received a message according to another embodiment;

FIGS. 8A-8B are block diagrams illustrating a mechanism for synchronizing actions among multiple INCDs according to one embodiment;

FIG. 9 is a block diagram of a computing device according to one embodiment; and

FIG. 10 is a block diagram of an edge node control device according to one embodiment.

### DETAILED DESCRIPTION

The embodiments set forth below represent the information to enable those skilled in the art to practice the embodiments and illustrate the best mode of practicing the embodiments. Upon reading the following description in light of the accompanying drawing figures, those skilled in the art will understand the concepts of the disclosure and will recognize applications of these concepts not particularly addressed herein. It should be understood that these concepts and applications fall within the scope of the disclosure and the accompanying claims.

Any flowcharts discussed herein are necessarily discussed in some sequence for purposes of illustration, but unless otherwise explicitly indicated, the embodiments are not limited to any particular sequence of steps. The use herein of ordinals in conjunction with an element is solely for distinguishing what might otherwise be similar or identical labels, such as “first internal node control device” and “second internal node control device,” and does not imply a priority, a type, an importance, or other attribute, unless otherwise stated herein. The term “about” used herein in conjunction with a numeric value means any value that is within a range of ten percent greater than or ten percent less than the numeric value.

As used herein, the articles “a” and “an” in reference to an element in the claims means one or more of the element, and does not imply only one of the element.

The embodiments relate to bi-directional communications on an electrical secondary networked distribution system. The embodiments facilitate communications between an edge node control device coupled to a secondary networked distribution system and a plurality of internal node control devices coupled to the secondary networked distribution system. The internal node control devices may be coupled to the secondary networked distribution system at locations where electrical control or monitoring are located. The edge node control device receives from an off-grid interface a message and, based on the message, communicates an instruction over the secondary networked distribution system to one or more internal node control devices. The edge node control device then determines that the one or more internal node control devices received the instruction.

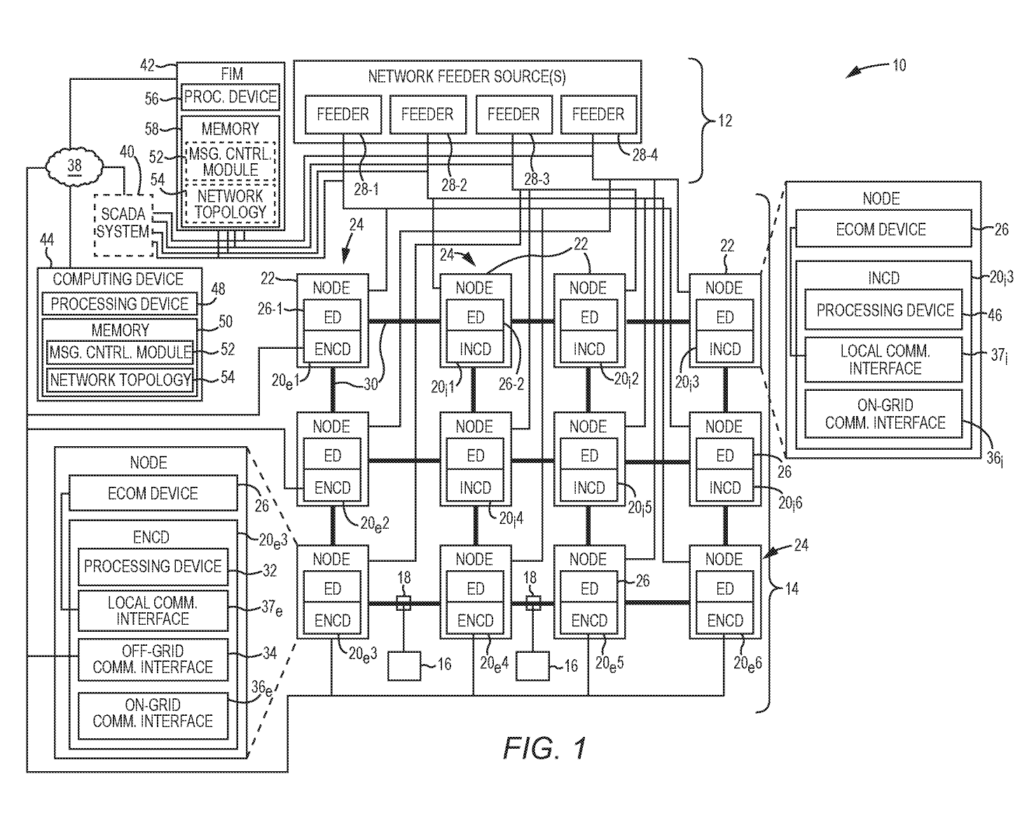

FIG. 1 is a block diagram of a system 10 in which embodiments may be practiced. The system 10 includes an electrical power primary distribution system 12 (hereinafter primary distribution system 12 for purposes of brevity) and an electrical power secondary networked distribution system 14 (hereinafter secondary networked distribution system 14 for purposes of brevity). The primary distribution system 12 receives electrical power from an electrical power transmission system (not illustrated). The primary distribution system 12 may distribute electricity at any desired voltage, but generally the primary distribution system 12 distributes electricity at a relatively high voltage of, by way of non-limiting example, between about 2 kV and 35 kV. The primary distribution system 12 provides electricity to one or more secondary distribution systems, such as the secondary networked distribution system 14.

The secondary networked distribution system 14 may distribute electricity at any desired voltage, but generally the secondary networked distribution system 14 distributes electricity at a relatively low voltage of, by way of non-limiting example, below about 2 kV. In the United States, for example, the secondary networked distribution system 14 typically distributes electricity at 120V, 240V, or 480V. The secondary networked distribution system 14 distributes electricity to a plurality of consuming endpoints 16. The consuming endpoints 16 may comprise, for example, residences, commercial enterprises, and the like. While only two consuming endpoints 16 are illustrated in FIG. 1, it will be appreciated that the secondary networked distribution system 14 could provide electricity to any number of consuming endpoints 16, and, in urban areas, may provide electricity to tens of thousands of consuming endpoints 16. Each consuming endpoint 16 may be coupled to the secondary networked distribution system 14 via a transformer 18 that steps the voltage of the secondary networked distribution system 14 down to a lower voltage, or, depending on the voltage of the secondary networked distribution system 14, may be directly coupled to the secondary networked distribution system 14 without a transformer 18.

The secondary networked distribution system 14 comprises a plurality of external node control devices (ENCDs) 20ₑ1-20ₑ6 (generally, ENCDs 20ₑ) and internal node control devices (INCDs) 20ᵢ1-20ᵢ6 (generally, INCDs 20ᵢ). The ENCDs 20ₑ and the INCDs 20ᵢ are distant from one another and are located at corresponding nodes 22 of the secondary networked distribution system 14. Note that for purposes of clarity only some of the nodes 22 are labeled with element reference numerals. Each node 22 is at a particular location 24 in particular geographical area serviced by the secondary networked distribution system 14. Note that for purposes of clarity only some of the locations 24 are labeled with element reference numerals. The nodes 22 identify locations 24 of the secondary networked distribution system 14 where an electrical control or monitoring (ECOM) device 26 is located. An ECOM device 26 can comprise any device that is configured to control, alter, halt, or monitor the electrical power on the secondary networked distribution system 14. An ECOM device 26 may comprise, by way of non-limiting example, a transformer, a switch, a fuse or a monitoring device. Note that for purposes of clarity only some of the ECOM devices 26 are labeled with element reference numerals.

The phrase “networked distribution system,” as used herein refers to an electrical power distribution system that receives electrical power from multiple feeders 28-1-28-4 (generally, feeders 28) of the primary distribution system 12, and thus multiple feeders 28 provide electrical power to the same nodes 22. An advantage of a networked distribution system is that if one feeder 28 goes down and fails to provide electrical power, the secondary networked distribution system 14 continues to receive electrical power from other feeders 28 such that the consuming endpoints 16 are not impacted by the feeder 28 that went down. A disadvantage of a networked distribution system is the cost. Other distribution systems, such as radial distribution systems, are less expensive but fail to provide the redundancy provided by a networked distribution system. A networked distribution system is often utilized in highly dense areas, such as urban areas of metropolitan cities.

Each or many of the nodes 22 may include a transformer that steps down the voltage from the primary distribution system 12 to the desired voltage of the secondary networked distribution system 14. Each transformer provides the stepped down voltage to an electrical grid 30 of the secondary networked distribution system 14. For example, an ECOM device 26-1 (ED) may comprise a transformer that receives electrical power from the feeder 28-1, steps down the voltage, and provides the electrical power to the grid 30. Similarly, an ECOM device 26-2 may comprise a transformer that receives electrical power from the feeder 28-2, steps down the voltage, and provides the electrical power to the grid 30. Each node 22 may contain any number of ECOM devices 26.

While, for purposes of illustration, the consuming endpoints 16 are illustrated as being coupled to the secondary networked distribution system 14 between two nodes 22, it will be appreciated that a consuming endpoint 16 may be coupled to the secondary networked distribution system 14 at a node 22.

The ENCD 20ₑ3 comprises a processing device 32, an off-grid communications interface 34 configured to communicate via an off-grid communications technology, and an on-grid communications interface 36ₑ configured to communicate over the grid 30 via an on-grid communications technology. The on-grid communications interface 36ₑ may comprise an on-grid receiver module configured to receive messages from the grid 30, and an on-grid transmitter module configured to transmit messages onto the grid 30. The off-grid communications technology may utilize any suitable communication medium such as a wired communication medium, a fiber communication medium, or a wireless communication medium. The off-grid communications technology may utilize any public or proprietary protocol for communications.

In this example, the ENCD 20ₑ3 communicates via the off-grid communications interface 34 with a network 38 to which a number of other processing devices are coupled. In particular, a supervisory control and data acquisition (SCADA) system 40, a feeder intelligence module (FIM) 42, and a computing device 44 may be communicatively coupled to the network 38. As will be described in greater detail herein, the ENCDs 20ₑ facilitate communications between one or more of the SCADA system 40, the FIM 42, the computing device 44, and the INCDs 20ᵢ. In one embodiment, use of the SCADA system 40 may be avoided through the mechanisms disclosed herein.

The ENCD 20ₑ3 is also communicatively coupled to an ECOM device 26 located at the node 22 at which the ENCD 20ₑ3 is located. This relationship may be referred to herein as a correspondence between the ENCD 20ₑ3 and the particular ECOM device 26 at the same location, such that each ENCD 20ₑ is communicatively coupled to a corresponding ECOM device 26 at the same location. The ENCD 20ₑ3 is configured to communicate with the corresponding ECOM device 26 via a local communications interface 37ₑ using any suitable communications technology, such as, by way of non-limiting example, a wired or wireless local area network. Thus, as will be described in greater detail herein, the ENCD 20ₑ3 may receive messages via the network 38 that direct the ENCD 20ₑ3 to communicate with the corresponding ECOM device 26. The communications may direct the ECOM device 26 to perform some action, alter some parameter of the ECOM device 26, request information from the ECOM device 26, or any combination of the above. The ENCDs 20ₑ1, 20ₑ2, and 20ₑ4-20ₑ6 are configured similarly to the ENCD 20ₑ3, and are similarly communicatively coupled to a corresponding ECOM device 26.

The INCD 20ᵢ3 comprises a processing device 46 and an on-grid communications interface 36ᵢ configured to communicate over the grid 30 via an on-grid communications technology. Unlike the ENCDs 20ₑ, the INCDs 20ᵢ may have no off-grid communications interface 34. Thus, in some embodiments, the INCDs 20ᵢ may communicate only over the grid 30 via an on-grid communications technology. The INCD 20ᵢ3 is also communicatively coupled to and configured to communicate via a local communications interface 37; with an ECOM device 26 co-located with the INCD 20ᵢ3 using any suitable communications technology, such as, by way of non-limiting example, a wired or wireless local area network. The INCDs 20ᵢ 1, 20ᵢ2, and 20ᵢ4-20ᵢ6 are configured similarly to the INCD 20ᵢ3, and are similarly communicatively coupled to a corresponding ECOM device 26.

In practice, the nodes 22 may be located in protected locations to prevent tampering. In urban environments, the nodes 22 may be located in underground vaults and may only be accessible via a manhole. Such underground vaults typically inhibit wireless communications with devices above ground. Moreover, due to the prohibitive cost, underground vaults frequently do not have communication lines interconnecting the underground vaults. Thus, providing communications to the equipment in the underground vaults can be impossible, or, if available, is limited to conventional on-grid communications mechanisms that communicate with the secondary networked distribution system 14 via the primary distribution system 12. Unfortunately, such conventional on-grid communications are relatively costly and have many limitations. Moreover, due to the physical expanse of the secondary networked distribution system 14, some nodes 22 may simply be out of signal reach of a transmitter located on the primary distribution system 12.

Among other features, the embodiments facilitate bi-directional communications on the secondary networked distribution system 14. Such bi-directional communications allow a device, such as the computing device 44, to control and/or monitor ECOM devices 26 located at each of the nodes 22. Such actions can comprise any suitable actions that the ECOM devices 26 are configured to implement. Such actions may also be coordinated such that the ECOM devices 26 perform actions in a particular sequence, or, the ECOM devices 26 may perform actions substantially concurrently.

In one embodiment, the ENCDs 20ₑ are located at one or more nodes 22 and coupled to an off-grid communications mechanism. For example, fiber or electrical lines may be run to the locations 24 at which the ENCDs 20ₑ are located. The number of locations 24 of the ENCDs 20ₑ may be a relatively small fraction of the number of locations 24 that house the INCDs 20ᵢ, such as 1/100th, 1/1000^{th}, or 1/10th. Thus, costs to run external communications to the nodes 22 that house the ENCDs 20ₑ are relatively minimal compared to the cost to run external communications to all the nodes 22.

The ENCDs 20ₑ communicate with the computing device 44, the SCADA system 40, and/or the FIM 42 via the respective off-grid communications interface 34 and the network 38. For purposes of illustration, many of the embodiments will be discussed herein in the context of the computing device 44 initiating and controlling communications on the secondary networked distribution system 14 via the ENCDs 20ₑ; however, the functionality attributed to the computing device 44 may be implemented in one or more other devices, such as the SCADA system 40 and the FIM 42. In one embodiment, the computing device 44 includes a processing device 48 and a memory 50. The memory 50 may include a message control module 52 that implements some or all of the functionality described herein with regard to the computing device 44. The message control module 52 may comprise complex software instructions, circuitry, and/or a combination of software instructions and circuitry. In some embodiments, the message control module 52 may be implemented in an applications-specific integrated circuit or a field programmable gate array.

The memory 50 may also include a network topology 54. The network topology 54 includes information regarding the ENCDs 20ₑ and the INCDs 20ᵢ, such as electronic device addresses of the ENCDs 20ₑ and the INCDs 20ᵢ to which messages may be addressed, the ECOM devices 26 in communication with the respective ENCDs 20ₑ and the INCDs 20ᵢ, locations of the ENCDs 20ₑ, INCDs 20ᵢ, and the ECOM devices 26, and the like.

The FIM 42 includes a processing device 56 and a memory 58. The FIM 42 is communicatively coupled to the feeders 28, and thus can receive on-grid communications from the ENCDs 20ₑ and the INCDs 20ᵢ. While downstream communications from higher voltage systems such as the primary distribution system 12 to lower voltage distribution systems such as the secondary networked distribution system 14 can be relatively costly and of limited effectiveness, upstream communications from the secondary networked distribution system 14 to the primary distribution system 12 are typically less costly and are generally more effective. Accordingly, in some embodiments, as will be discussed in greater detail below, the ENCDs 20ₑ and the INCDs 20ᵢ may send messages to the message control module 52 via the FIM 42 to, in part, implement the bi-directional communications disclosed herein. As discussed above, in some embodiments the message control module 52 and the network topology 54 may be implemented in the FIM 42 rather than the computing device 44.

Each feeder 28 may have three phases separated by 120 degrees. Such phases are sometimes referred to as the “A phase,” the “B phase,” and the “C phase.” In the secondary networked distribution system 14 the A phases from each feeder 28 are connected together; the B phases are connected together; and the C phases are connected together. These interconnected phases facilitate parallel communication paths by which an ENCD 20ₑ or INCD 20ᵢ can send transmissions to the FIM 42. Moreover, these interconnected phases facilitate multiple communication paths between ENCDs 20ₑ and INCDs 20ᵢ.

In one embodiment, the ENCDs 20ₑ and the INCDs 20ᵢ communicate over the grid 30 by an injection of a modulated current signal on one or more phases of the secondary networked distribution system 14 during message transmission, and by receipt of a modulated voltage signal on the same one or more phases during message reception.

The injection of the modulated current signal on a phase or phases creates a corresponding small modulated voltage signal or signals due to the impedance of the phase, or phases, at the point of injection as seen by the transmitting ENCD 20ₑ or INCD 20ᵢ. This complex impedance varies by frequency of transmission, by voltage and phase angle of the mains power (for example, 120 volts, 240 volts, or 480 volts, at 50 Hz, 60 Hz, 400 Hz, or others), and by the consuming loads on the associated phase at the point of injection. It is this resultant modulated voltage signal that is used by the ENCDs 20ₑ and the INCDs 20ᵢ for reception.

Due to the interconnected nature of the phases of the secondary networked distribution system 14, both the modulated current signal and the modulated voltage signal propagate along an origin phase, or phases, in all possible directions from the point of injection, as well as along the interconnected phases and along any cross-coupled communication paths. Signals along the interconnected phases are attenuated more quickly than along the origin phase, which can result in a need for signal repeaters in some embodiments.

The current signal transmitted by either the ENCDs 20ₑ or the INCDs 20ᵢ propagates along the phase, or phases, and can be received at the FIM 42 in a substation that provides power to the secondary networked distribution system 14 by reception and demodulation of the current signal, or signals. The current signal, or signals, is available at the FIM 42 by monitoring 5 ampere (A) current loops of substation protection current transformers (CTs) which provide signal to a protection relay system and/or the SCADA system 40. Each phase powering the secondary networked distribution system 14 has a corresponding CT. This monitoring can be achieved by placing a small signal CT on each of the 5 A current loops and providing the output of the small signal CTs directly to the FIM 42. The FIM 42 contains one or more demodulators in which each small signal CT is directly connected to the input of a corresponding demodulator.

Furthermore, due to the physical proximity of the phases to each other, the presence of three phase transformers and three phase consuming loads, and the frequency of transmission by each ENCD 20ₑ or INCD 20ᵢ, the modulated current signal can be electrically or magnetically cross-coupled between phases. This further increases the number of communication paths at the feeder level while also creating a multiplicity of communications paths at the phases of the secondary networked distribution system 14. Thus, cross-coupling, which is normally a problem in communications systems, can be exploited in the secondary networked distribution system 14.

The modulated current signal can be implemented using a variety of modulation and demodulation methodologies, including, but not limited to: Binary Phase Shift Keying (BPSK), Quadrature Phase Shift Keying (QPSK), Frequency Shift Keying (FSK), Multi-Frequency Shift Keying (MFSK), and the like. Likewise, multiple frequencies can be utilized, creating one or more discrete communications channels. The channel, or channels, may be further segmented using such techniques such as Time Division Multiple Access (TDMA) implemented in a slotted structure, or in an un-slotted structure with a random transmission protocol such as Aloha.

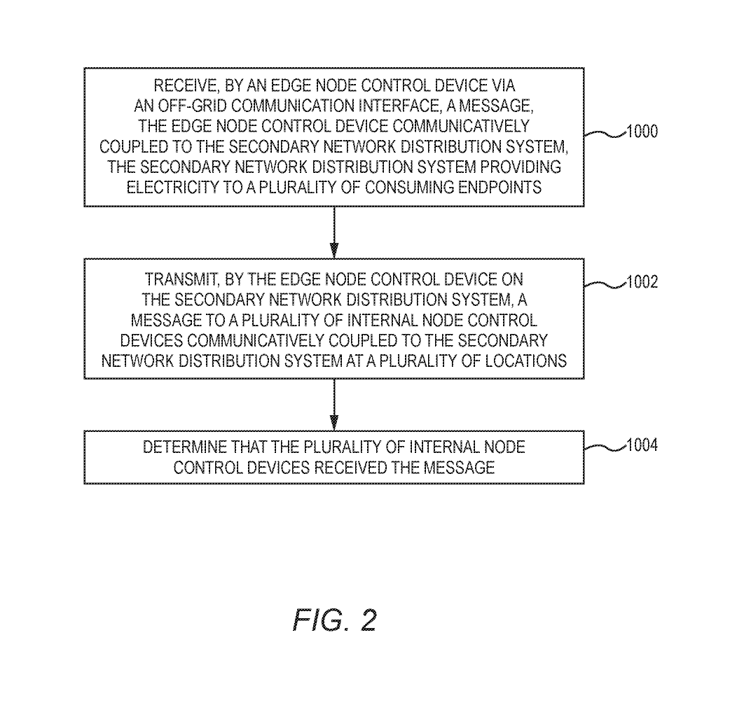

FIG. 2 is a flowchart illustrating a method for communicating on the secondary networked distribution system 14 according to one embodiment. FIG. 2 will be discussed in conjunction with FIG. 1. The ENCD 20ₑ3 receives, via the off-grid communications interface 34, a message from the computing device 44 (FIG. 2, block 1000). The message may be addressed to a particular INCD 20ᵢ, all INCDs 20ᵢ, or a group of INCDs 20ᵢ. In this example, assume that the message is destined for two particular INCDs 20ᵢ. The message may contain an action, or a script of actions, that the two INCDs 20ᵢ are to perform. In response to receipt of the message, the ENCD 20ₑ3 re-transmits the message on the secondary networked distribution system 14 via the on-grid communications interface 36ₑ (FIG. 2, block 1002). The on-grid communications interface 36ₑ may communicate over a particular phase of the secondary networked distribution system 14, or may communicate over all three phases of the secondary networked distribution system 14. The re-transmitted message may be identical to the received message, or the ENCD 20ₑ3 may reformat the message for transmission on the grid 30. Because the INCDs 20ᵢ are all coupled to the grid 30, the INCDs 20ᵢ all receive the message substantially concurrently, such as within the amount of time it takes for a signal to propagate from the ENCD 20ₑ3 to the INCD 20ᵢ farthest from the ENCD 20ₑ3.

It is determined that the two INCDs 20ᵢ to which the message was destined received the message (FIG. 2, block 1004). In one embodiment, the determination may be made by the computing device 44. As will be discussed in greater detail herein, the determination may be made in any number of different ways. If it had been determined that the one or both INCDs 20ᵢ had not received the message, the computing device 44 may resend the message to the ENCD 20ₑ3 for retransmission on the grid 30.

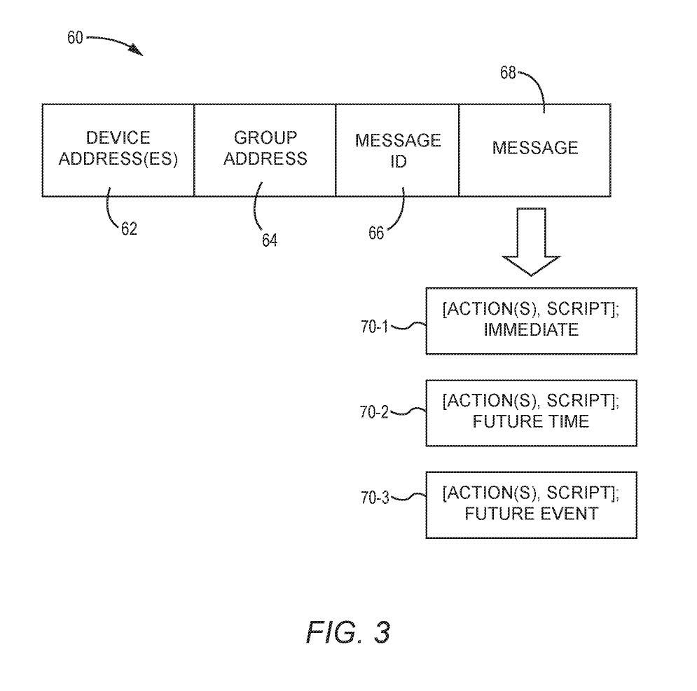

FIG. 3 is a block diagram illustrating a message layout 60 of a message according to one embodiment. The message layout 60 may be utilized by the computing device 44 to send messages to the ENCDs 20ₑ and the INCDs 20ᵢ. In this embodiment, the message layout 60 includes a device address field 62 in which the computing device 44 may identify device addresses, or device identifiers, of particular ENCDs 20ₑ and INCDs 20ᵢ to which the message may be specifically directed, if appropriate. For example, the computing device 44 may desire that an action be taken by one or more particular ENCDs 20ₑ and/or INCDs 20ᵢ, but not all ENCDs 20ₑ and INCDs 20ᵢ. The computing device 44 may then identify the particular ENCDs 20ₑ and/or INCDs 20ᵢ via the device address field 62. In one embodiment, the computing device 44 may utilize a broadcast device address in the device address field 62 to indicate that the message is directed to all ENCDs 20ₑ and INCDs 20ᵢ.

In some embodiments, multiple ENCDs 20ₑ and/or INCDs 20ᵢ may be identified by a particular group address in a group address field 64. A group address is associated with a particular set, or group, of ENCDs 20ₑ and/or INCDs 20ᵢ that may, for certain actions, operate in conjunction to cause the action to occur. The actions may be performed substantially concurrently or in a particular sequence. The phrase “substantially concurrently” refers to actions that take place within a period of time less than or equal to a time it takes for a message transmitted on the grid 30 to reach each of the ENCDs 20ₑ and/or INCDs 20ᵢ. Generally, such time is a function of the greatest distance between any INCD 20ᵢ and the closest ENCD 20ₑ.

The computing device 44 may insert a unique message identifier (ID) in a message ID field 66 to uniquely identify messages communicated on the grid 30. In some embodiments, the ENCDs 20ₑ and the INCDs 20ᵢ may use the unique message ID in acknowledgement responses to indicate successful receipt of the message.

The computing device may insert a particular message in a message field 68. The message may comport with any desired syntax and protocol known by the ENCDs 20ₑ and the INCDs 20ᵢ. In one embodiment, a message type 70-1 includes an action or actions, or a script, and an indication that the action is to be taken or the script executed upon receipt (i.e., immediately). The script may comprise a listing of actions and, in some embodiments, may comprise a language syntax that includes conditions, branches, and the like to control which actions are to be performed. The actions may include instructions or control signals that the respective ENCDs 20ₑ and INCDs 20ᵢ send to a corresponding ECOM device 26 co-located with the respective ENCDs 20ₑ and INCDs 20ᵢ. Thus, the ENCDs 20ₑ and the INCDs 20ᵢ may, in response to the receipt of a message, control a corresponding ECOM device 26.

A message type 70-2 includes an action or actions, or a script, and an indication that the action is to be taken at a future time. The future time may be a relative time offset from the time of receipt of the message, or may be a definite time. A message type 70-3 includes an action or actions, or a script, and an indication that the action is to be taken at a future event. It should be apparent that the message layout 60 is but one possible message layout, and the embodiments are not limited to any particular message layout.

While any suitable scripting language may be utilized in the embodiments, generally, a scripting language (sometimes referred to as a rules-based language) facilitates the transmission of a sequence of commands which are executed by a receiving ENCD 20ₑ or INCD 20ᵢ upon an event or sequence of events, a particular date/time, a condition, or any combination thereof. Non-limiting examples of a script syntax and commands are provided below.

The script command: “@T=X;S1=F” may be interpreted as: “At time X turn switch 1 off.” The script command: “@V<125;S2=O” may be interpreted as: “When the voltage is less than 125 volts then turn switch 1 on.” The script command: “1@T>Y;2@V<120;S2=0” may be interpreted as: “If the time is later than X and the voltage is less than 125 volts then turn switch 2 on.” The script command: “@f=1200,ST=0” may be interpreted as: “At reception of a 1200 Hz tone, set the time to zero.”

Multiple scripts may be sent to and retained by a receiving ENCD 20ₑ or INCD 20ᵢ. For example, the following scripts could be sent to a receiving ENCD 20ₑ or INCD 20ᵢ: “@T=X;S1=F. @V<125;S2=O. 1@T>Y;2@V<120;S2=0. @f=1200,ST=0.” such that the actions discussed above could be performed at the appropriate time and/or event.

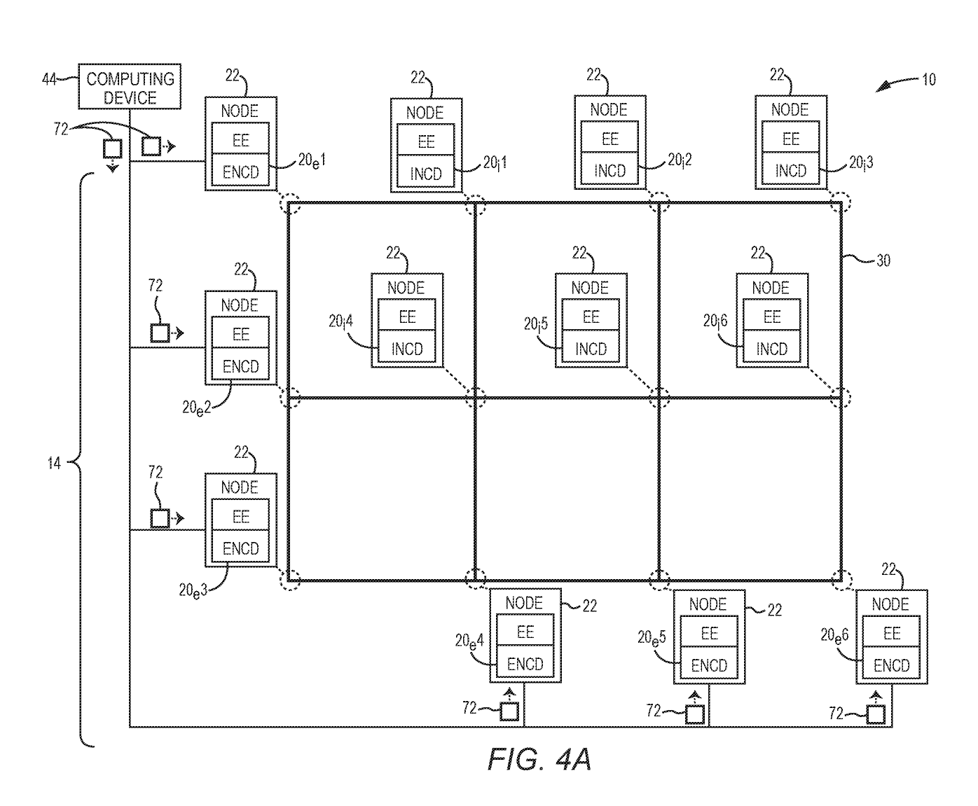

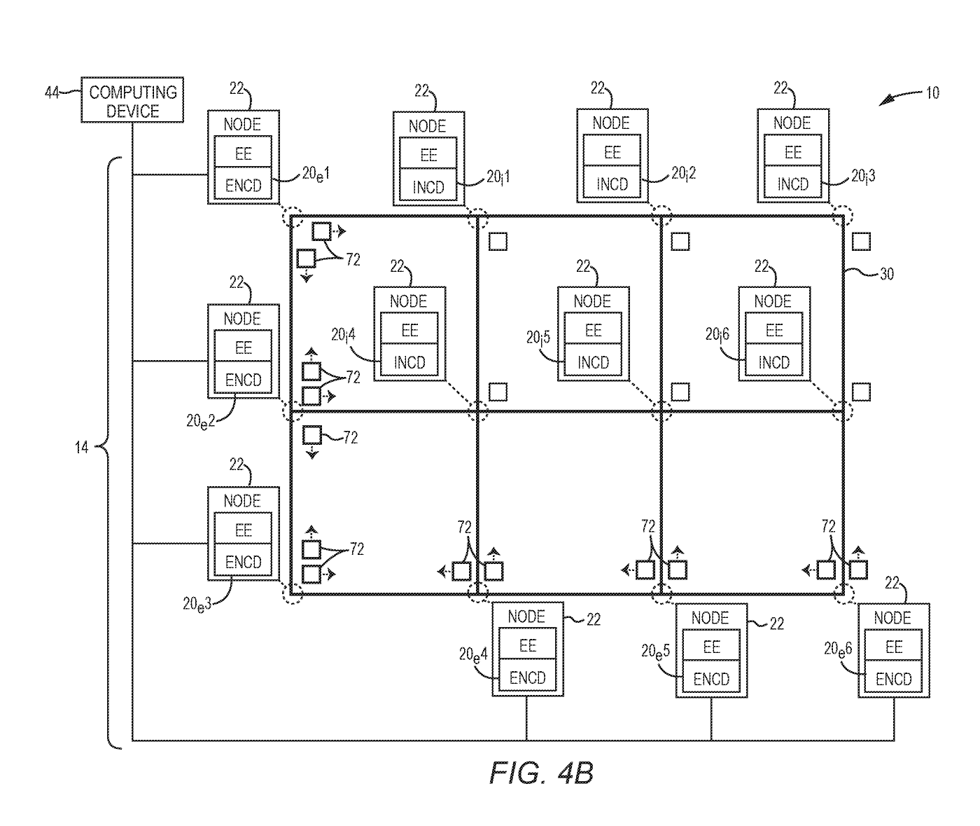

FIGS. 4A-4B illustrate a communication of messages on the secondary networked distribution system 14 according to one embodiment. In FIGS. 4A-4B, and subsequent figures discussed herein, portions of the primary distribution system 12 have been omitted solely for purposes of clarity but are functional in the embodiments as described above. FIGS. 4A-4B also illustrate the nodes 22 a distance from the grid 30 solely to facilitate discussion of message communications on the secondary networked distribution system 14. Thus, in operation, a portion of the grid 30 is coupled to the ENCDs 20ₑ and the INCDs 20ᵢ, as indicated by the dashed lines and circles extending from each node 22 to the grid 30.

For purposes of illustration, assume that the computing device 44 communicates a message 72 to the ENCDs 20ₑ at a time T1. The ENCDs 20ₑ receive the message 72 substantially concurrently. FIG. 4B illustrates each ENCD 20ₑ retransmitting the message 72 on the grid 30 beginning at a time T2 in response to receiving the message 72. The ENCDs 20ₑ may communicate on the grid 30 using any desired protocol for communicating on a shared medium, including, by way of non-limiting example, a random transmission protocol, such as Aloha, or a slotted transmission protocol, such as slotted Aloha. In some embodiments, where a single ENCD 20ₑ can reach all the INCDs 20ᵢ via the grid 30, the ENCD 20ₑ may communicate messages individually to each INCD 20ᵢ. The retransmitted message 72 may be a copy of the message 72 or may be reformatted by the ENCDs 20ₑ prior to retransmission. Note that because the grid 30 is a shared medium, the retransmitted message 72 is received substantially concurrently by each of the INCDs 20ᵢ. Note that each INCD 20ᵢ may receive the retransmitted message 72 multiple times. Further note that the strength of the retransmitted message 72 may differ depending on the distance between the nearest transmitting ENCD 20ₑ and the respective INCD 20ᵢ.

The message 72 may have been identified by the computing device 44 as a broadcast message that is destined for each INCD 20ᵢ, may have been addressed to one or more specified INCDs 20ᵢ, or may have been directed to a group of INCDs 20ᵢ utilizing a group address. Each INCD 20ᵢ receives the retransmitted message 72, examines the retransmitted message 72 to determine whether the retransmitted message 72 is intended for the INCD 20ᵢ, and if so, performs the action indicated in the retransmitted message 72.

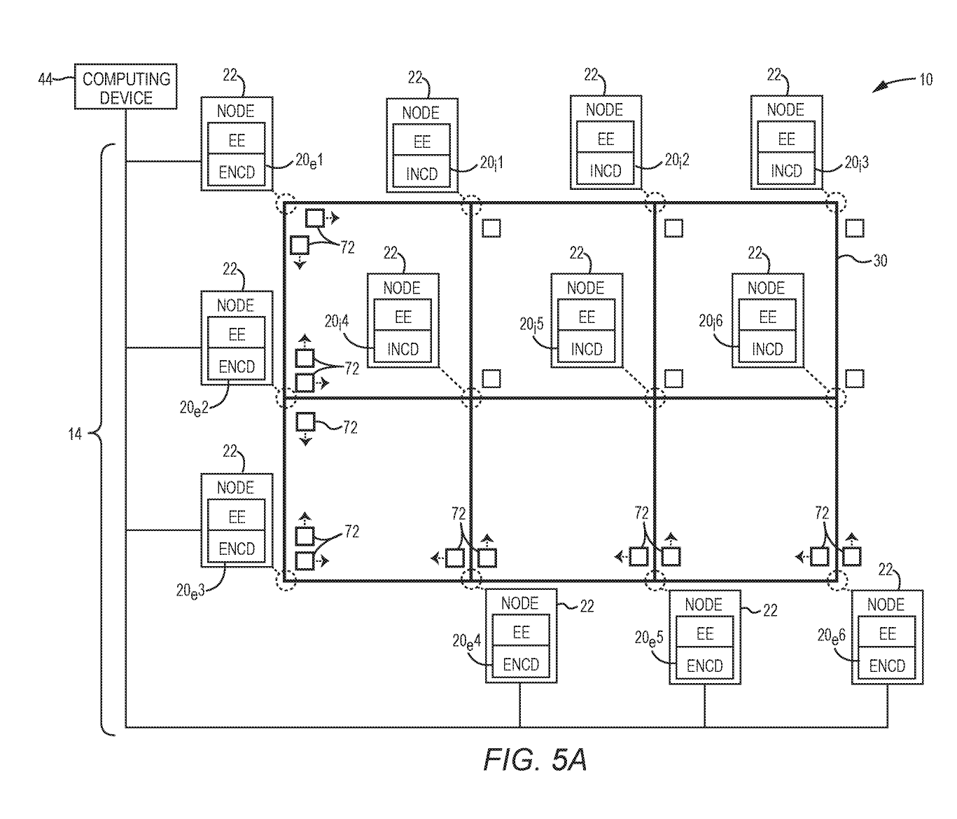

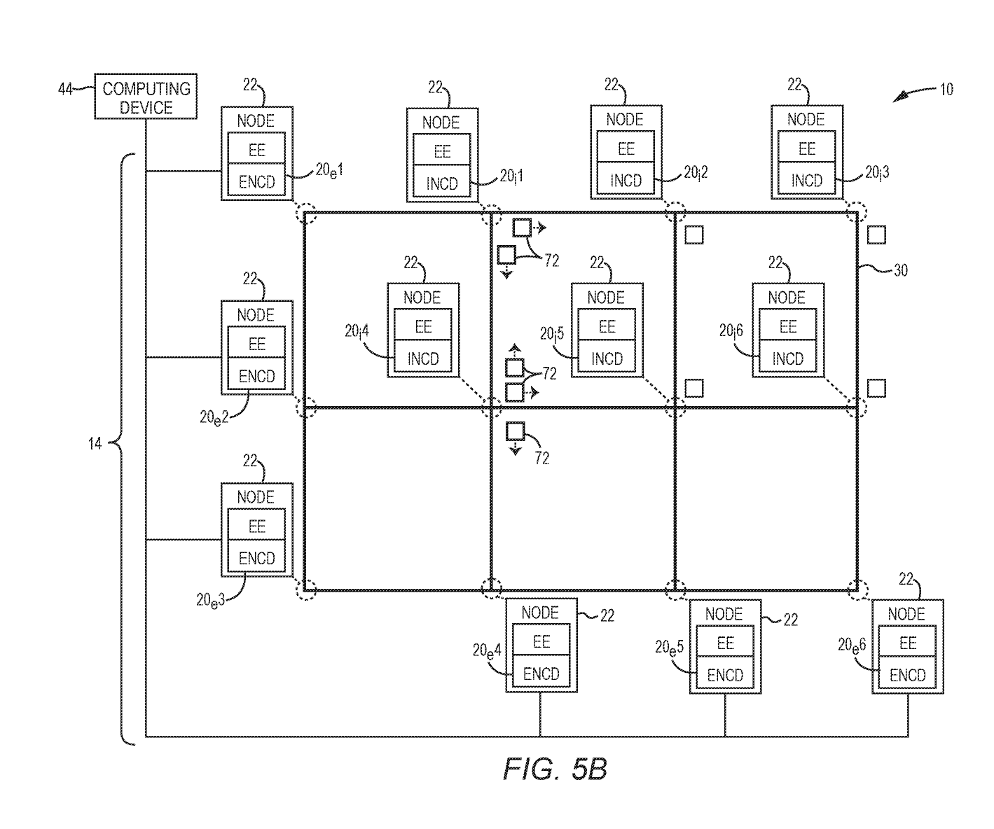

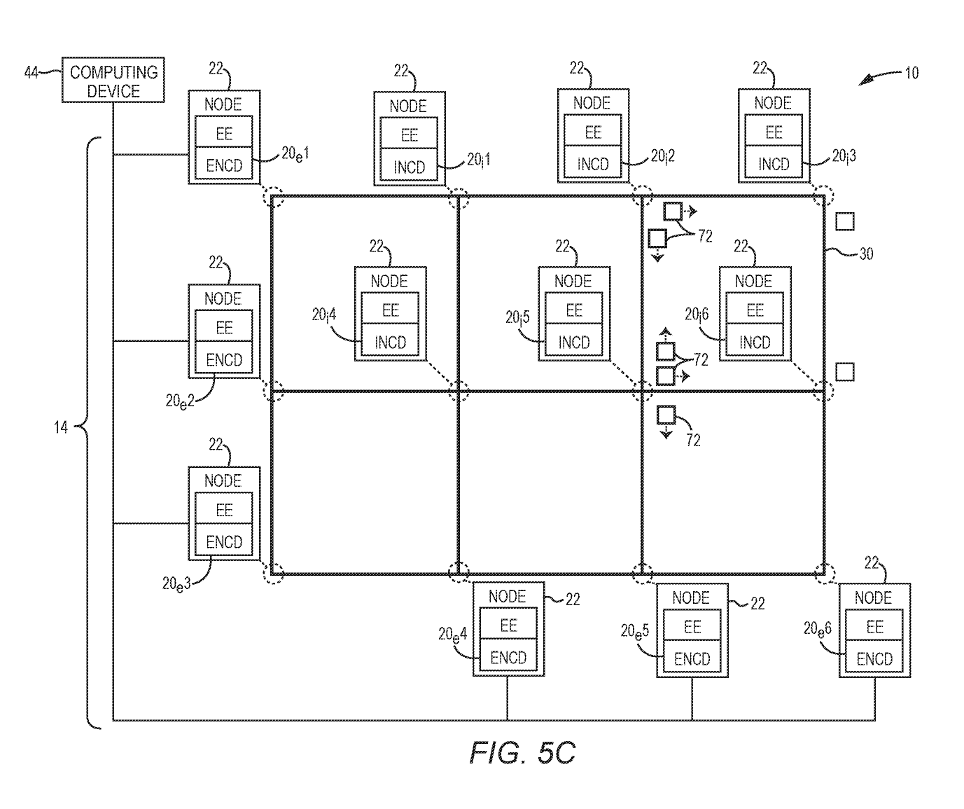

FIGS. 5A-5B illustrate a store-and-forward communication of messages on the secondary networked distribution system 14 according to another embodiment. Referring first to FIG. 5A, assume that, as illustrated in FIG. 4A, each ENCD 20ₑ received the message 72 from the computing device 44. At a time T2, each ENCD 20ₑ retransmits the message 72 on the grid 30 in response to receiving the message 72. The retransmitted message 72 may be a copy of the message 72 or may be reformatted by the ENCDs 20ₑ prior to retransmission. Note that because the grid 30 is a shared medium, the retransmitted message 72 is received substantially concurrently be each of the INCDs 20ᵢ. Note that each INCD 20ᵢ may receive the retransmitted message 72 multiple times. Further note that the strength of the retransmitted message 72 may differ depending on the distance between the nearest transmitting ENCD 20ₑ and the respective INCD 20ᵢ.

Referring to FIG. 5B, after receiving the retransmitted message 72, the INCDs 20ᵢ 1 and 20ᵢ4 again retransmit the message 72 on the grid 30. The retransmitted message 72 is received by the INCD 20ᵢ 2, the INCD 20ᵢ3, the INCD 20ᵢ5, and the INCD 20ᵢ 6. Referring to FIG. 5C, after receiving the message 72, the INCDs 20ᵢ 2 and 20ᵢ5 again retransmit the message 72 on the grid 30. Thus, in this embodiment, the message 72 is repeatedly propagated along the grid 30 by the INCDs 20ᵢ. This ensures that INCDs 20ᵢ farther from a transmitting ENCD 20ₑ ultimately receive the message 72, irrespective of the distance of the INCD 20; from the nearest ENCD 20ₑ. The ENCDs 20ₑ may communicate on the grid 30 using any desired protocol for communicating on a shared medium, including, by way of non-limiting example, a random transmission protocol, such as Aloha, or a slotted transmission protocol, such as slotted Aloha.

While for purposes of illustration each downstream INCD 20ᵢ is illustrated as retransmitting the message 72, in other embodiments only certain INCDs 20ᵢ may retransmit the message 72. In particular, in one embodiment, it may be determined, based on testing the grid 30, that certain INCDs 20ᵢ will receive the retransmitted message 72 from the ENCDs 20ₑ, and others, due to distance and/or noise, will not. In such situations, only particular INCDs 20ᵢ nearest those INCDs 20ᵢ that do not receive the original message 72 may be configured to retransmit the message 72. For example, assume that, based on predetermined testing of the grid 30, it is determined that the INCDs 20ᵢ 1, 20ᵢ2, 20ᵢ4, and 20ᵢ5 will receive the retransmitted message 72 with sufficient signal strength from the original retransmissions of the ENCD 20ₑ, but that the INCDs 20ᵢ3, 20ᵢ6 will not. It is further determined that the INCDs 20ᵢ 3, 20ᵢ6 do receive messages 72 retransmitted from the INCDs 20ᵢ 2, 20ᵢ5. In this situation, only the INCDs 20ᵢ 2, 20ᵢ5 may be configured to retransmit the message 72.

In another embodiment, the appropriate retransmission by the INCDs 20; may be determined dynamically or heuristically. In particular, based on acknowledgement messages (ACKs) and/or negative acknowledgement messages (NACKs) received from the INCDs 20ᵢ after the retransmission of a message 72 from the ENCDs 20ₑ, the computing device 44 may determine which INCDs 20ᵢ routinely receive the initial retransmission of a message 72 from the ENCDs 20ₑ, and which INCDs 20ᵢ do not. The computing device 44 may access the network topology 54, determine which INCDs 20ᵢ are closest to those INCDs 20; that do not receive the initial retransmission of a message 72 from the ENCDs 20ₑ, and send such closest INCDs 20ᵢ a configuration instruction that configures the INCDs 20ᵢ to retransmit messages 72 on the grid 30.

In some embodiments, the originating sender of the message 72, in the previous examples the computing device 44, may determine whether the ENCDs 20ₑ and the INCDs 20ᵢ to which the message 72 was destined received the message 72. In one embodiment, this determination may be made using a negative acknowledgement by exception protocol, wherein the computing device 44 determines that the ENCDs 20ₑ and the INCDs 20ᵢ to which the message 72 was destined received the message 72, unless a NACK is sent from the ENCDs 20ₑ and the INCDs 20ᵢ. Thus, in this embodiment, if no NACK is received by the computing device 44 within a predetermined timeframe, the computing device 44 makes a determination that the ENCDs 20ₑ and the INCDs 20ᵢ to which the message 72 was destined received the message 72.

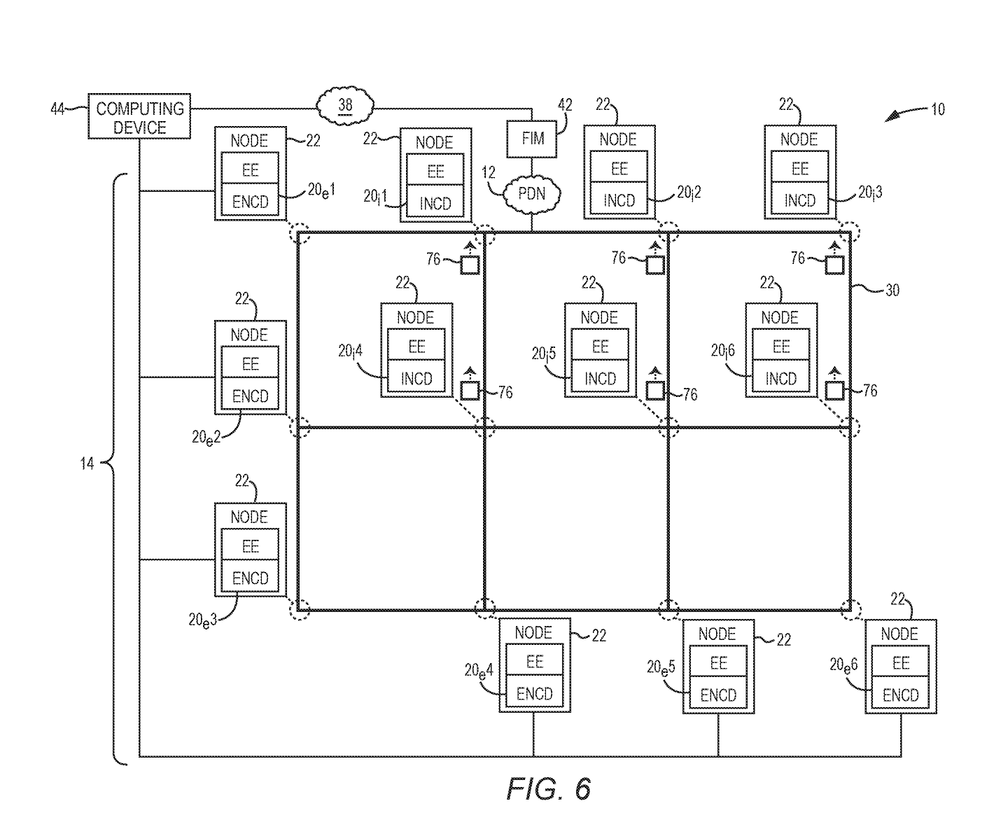

FIG. 6 illustrates a mechanism for determining that the ENCDs 20ₑ and the INCDs 20ᵢ received a message 72 according to another embodiment. In this embodiment, each ENCD 20ₑ and INCD 20ᵢ to which the message 72 was destined sends an ACK 76 upon successful receipt of the message 72. The ACKs 76 may contain, for example, a device ID identifying the particular INCD 20ᵢ, as well as the message ID of the message 72. In this example, assume that the message 72 was identified as a broadcast message that was destined for each ENCD 20ₑ and INCD 20ᵢ. Upon receiving the message 72, the INCDs 20ᵢ send an ACK 76 over the grid 30 via the secondary networked distribution system 14 to the primary distribution system 12. The FIM 42 monitors and analyzes signals on the primary distribution system 12 and receives the ACKs 76. The FIM 42 may communicate the ACKs 76 to the computing device 44. The computing device 44 may maintain information regarding each message ID and which INCDs 20ᵢ and ENCDs 20ₑ have sent ACKs 76, and thereby may determine which INCDs 20ᵢ and ENCDs 20ₑ have received the message 72. While not illustrated in FIG. 6, each ENCD 20ₑ may similarly communicate an ACK 76 over the grid 30 via the secondary networked distribution system 14 to the primary distribution system 12, or, alternatively, may send an ACK 76 directly to the computing device 44 using respective off-grid communications interfaces 34.

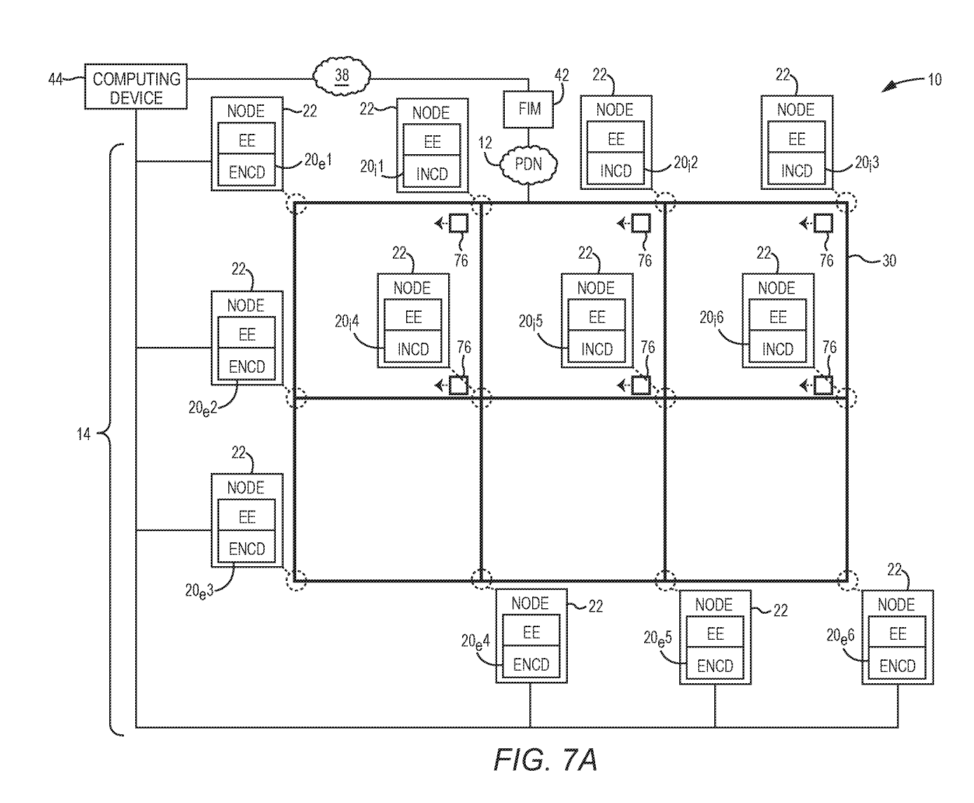

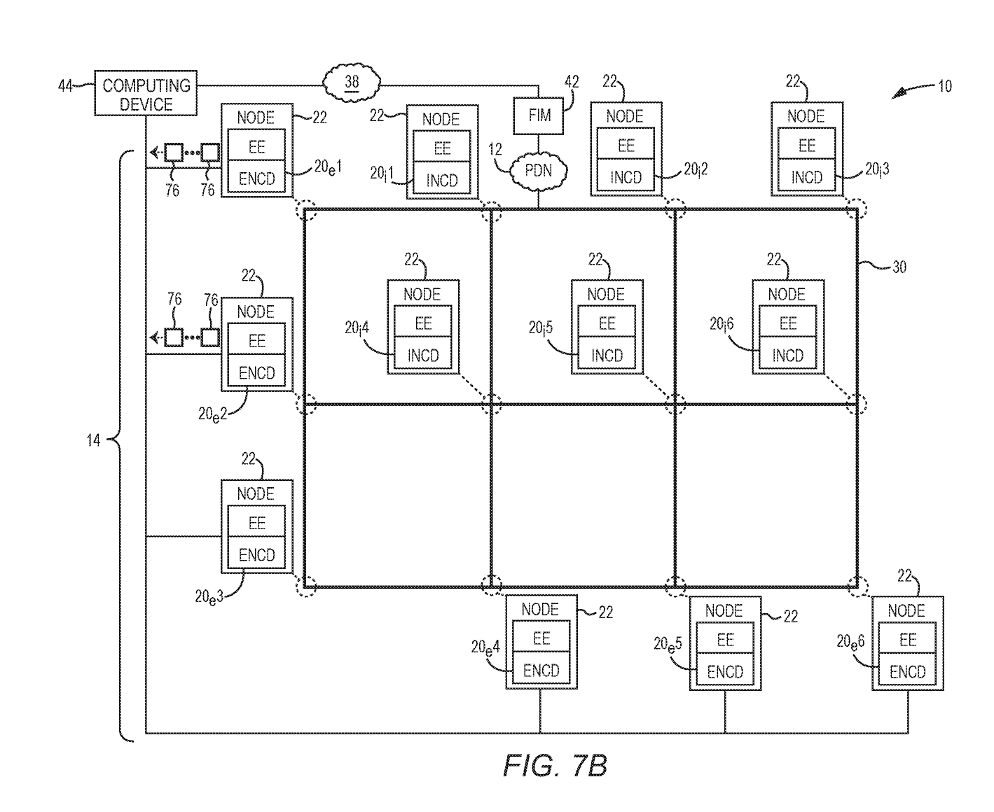

FIGS. 7A-7B illustrate a mechanism for determining that the ENCDs 20ₑ and the INCDs 20ᵢ have successfully received a message 72 according to another embodiment. In this embodiment, assume again that the message 72 was identified as a broadcast message by the computing device 44 and was destined for each ENCD 20ₑ and INCD 20ᵢ. As illustrated in FIG. 7A, upon receipt of the message 72, each INCD 20ᵢ generates an ACK 76, as described above, and transmits the ACK 76 onto the grid 30. In this embodiment, the ENCDs 20ₑ receive the ACKs 76. Referring to FIG. 7B, each ENCD 20ₑ retransmits the ACKS 76 to the computing device 44 using the off-grid communications interface 34. Note that while only the ENCDs 20ₑ1 and 20ₑ2 are illustrated as retransmitting the ACKs 76, the ENCDs 20ₑ3-20ₑ6 may also retransmit received ACKs 76. Because each ENCD 20ₑ may be unaware of which ACKs 76 are being retransmitted by the other ENCDs 20ₑ, the computing device 44 may receive multiple copies of an ACK 76 from the same INCD 20ᵢ.

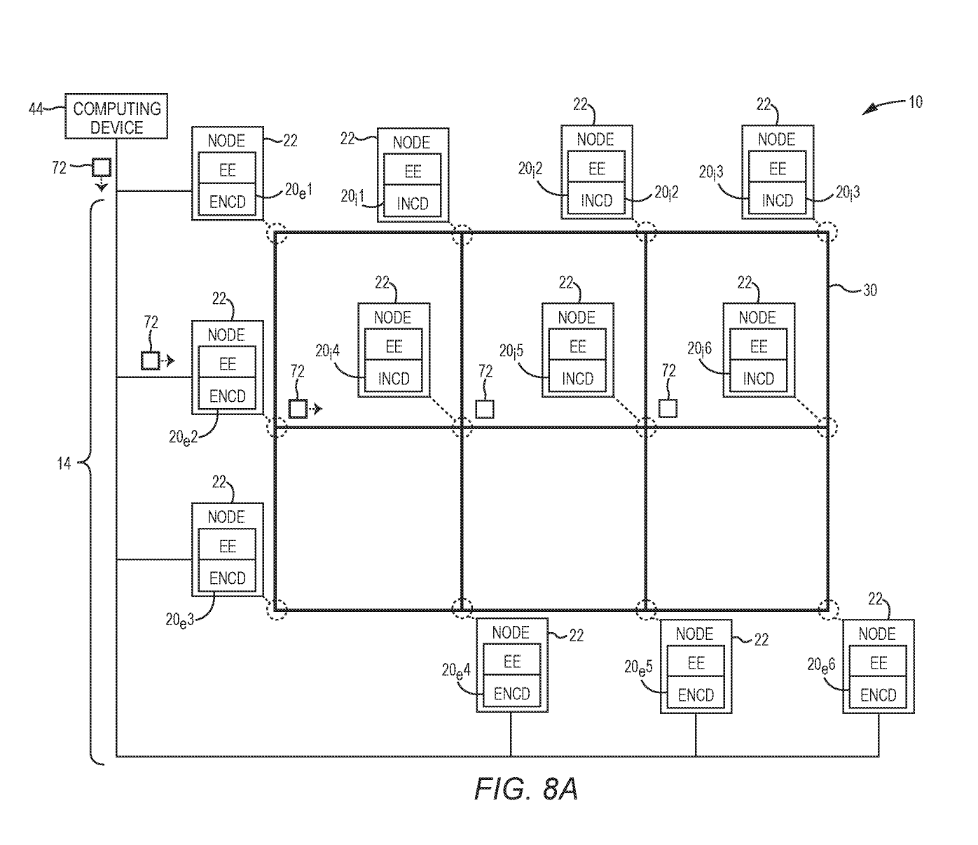

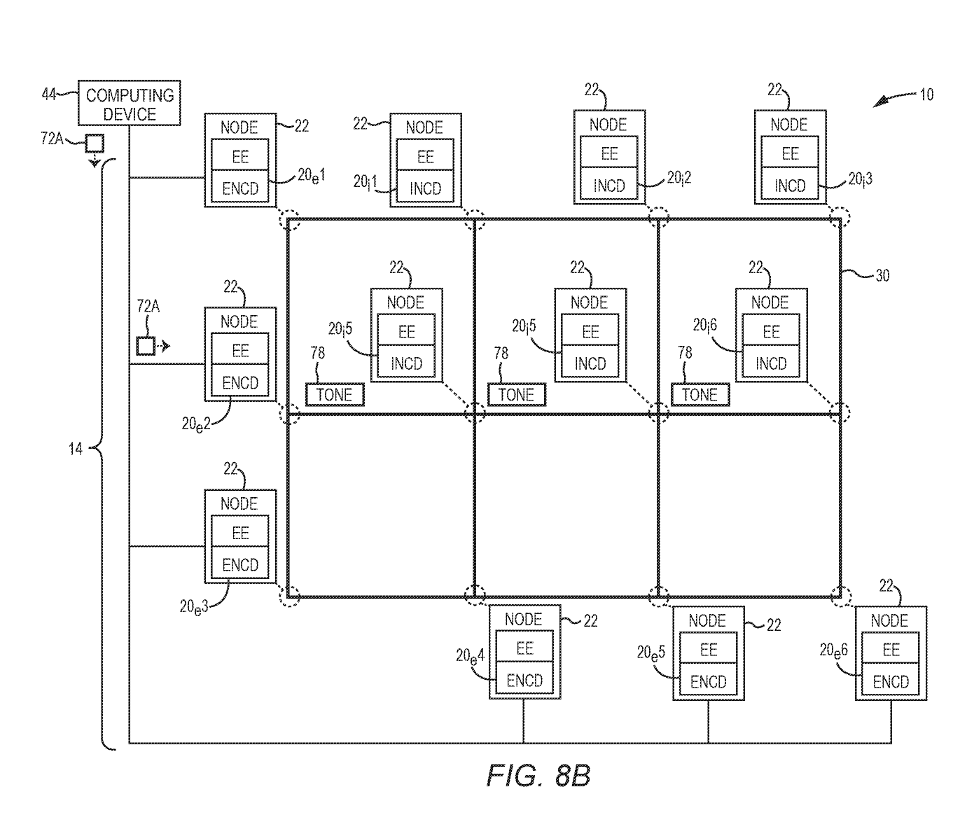

FIGS. 8A-8B illustrate a mechanism for synchronizing actions among multiple INCDs 20ᵢ according to one embodiment. In this example, assume that the computing device 44 generates a message 72 destined for the INCDs 20ᵢ 4, 20ᵢ5. The message 72 identifies an action that should be taken by the INCDs 20ᵢ 4, 20ᵢ5 substantially concurrently. The ENCDs 20ₑ receive the message and transmit the message 72 onto the grid 30. The INCDs 20ᵢ 4 and 20ᵢ5 receive the message and may transmit ACKs 76, as discussed above, to indicate receipt. The message 72, in this example, is a message type 70-3 (FIG. 3) and indicates that the action should be performed by the INCDs 20ᵢ 4, 20ᵢ5 upon the occurrence of a future event. In this example, the future event is identified as the detection of a tone on the grid 30. The INCDs 20ᵢ 4, 20ᵢ5 listen, such as by monitoring, to the grid 30 for the presence of the tone. FIG. 8A illustrates the computing device 44 sending a message 72A that is destined for the ENCD 20ₑ2. The message indicates that upon receipt of the message 72A, the ENCD 20ₑ2 should apply a tone to the grid 30. FIG. 8B illustrates the ENCD 20ₑ2 receiving the message 72A and applying a tone 78 to the grid 30. Because the grid 30 is a shared medium, the tone 78 is received by the INCDs 20ᵢ4, 20ᵢ5 substantially concurrently. The INCDs 20ᵢ 4, 20ᵢ5, in response to detecting the presence of the tone 78 on the secondary networked distribution system 14, perform the action(s) designated in the message 72A.

In other embodiments, the computing device 44 may send a series of messages to different ENCDs 20ₑ and INCDs 20ᵢ that identify different actions to be processed in sequence. The communication of such messages and determinations of receipt of such messages may be accomplished by one or more of the methods discussed above. Each message may designate that the respective action be performed at a particular time, and each time may differ to ensure the actions are performed in a proper sequence. To ensure proper coordination, the ENCDs 20ₑ and the INCDs 20ᵢ may periodically synchronize internal clocks so that such clocks are within a predetermined synchronization. Such synchronization may be accomplished in any desired manner.

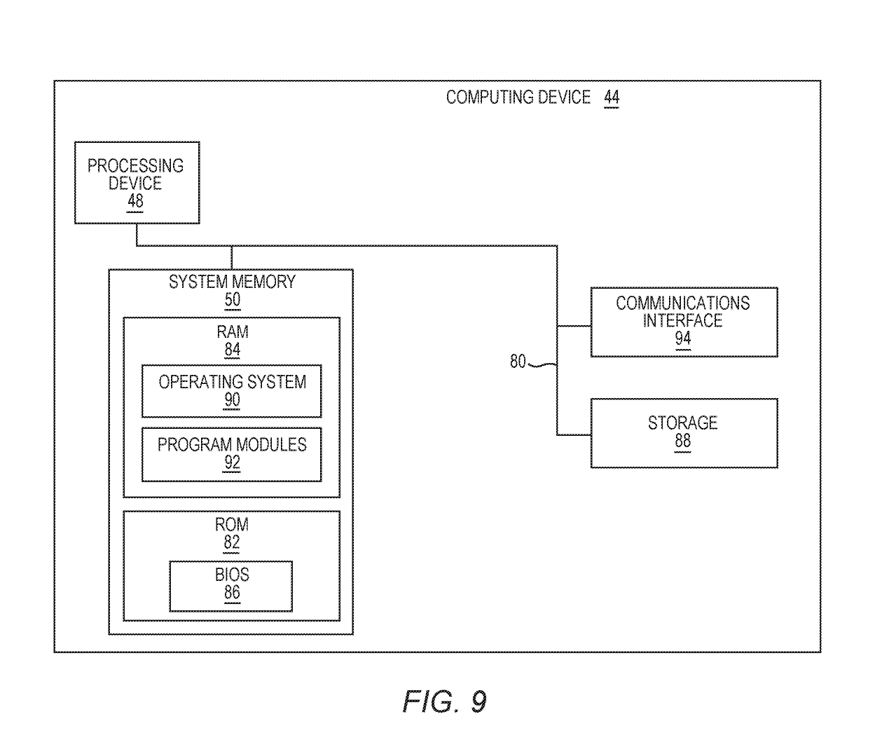

FIG. 9 is a block diagram of the computing device 44 according to one embodiment. The computing device 44 may comprise any computing or processing device capable of including firmware, hardware, and/or executing software instructions to implement the functionality described herein, such as a computer server, workstation, or the like. In some embodiments, the computing device 44 may be a special-purpose computing system designed to implement communications power system communications as disclosed herein. The computing device 44 includes the processing device 48, the system memory 50, and a system bus 80. The system bus 80 provides an interface for system components including, but not limited to, the system memory 50 and the processing device 48. The processing device 48 can be any commercially available or proprietary processor.

The system bus 80 may be any of several types of bus structures that may further interconnect to a memory bus (with or without a memory controller), a peripheral bus, and/or a local bus using any of a variety of commercially available bus architectures. The system memory 50 may include non-volatile memory 82 (e.g., read-only memory (ROM), erasable programmable read-only memory (EPROM), electrically erasable programmable read-only memory (EEPROM), etc.) and/or volatile memory 84 (e.g., random-access memory (RAM)). A basic input/output system (BIOS) 86 may be stored in the non-volatile memory 82, and may include basic routines that help to transfer information between elements within the computing device 44. The volatile memory 84 may also include a high-speed RAM, such as static RAM for caching data.

The computing device 44 may further include or be coupled to a computer-readable storage 88, which may comprise, for example, an internal or external hard disk drive (HDD) (e.g., enhanced integrated drive electronics (EIDE) or serial advanced technology attachment (SATA)), HDD (e.g., EIDE or SATA) for storage, flash memory, or the like. The computer-readable storage 88 and other drives associated with computer-readable media and computer-usable media may provide non-volatile storage of data, data structures, computer-executable instructions, and the like. Although the description of computer-readable media above refers to an HDD, it should be appreciated by those skilled in the art that other types of media that are readable by a computer, such as Zip disks, magnetic cassettes, flash memory cards, cartridges, and the like, may also be used in the exemplary operating environment, and further, that any such media may contain computer-executable instructions for performing novel methods of the disclosed architecture.

A number of modules can be stored in the computer-readable storage 88 and in the volatile memory 84, including an operating system 90 and one or more program modules 92, which may implement the functionality described herein in whole or in part. It is to be appreciated that the embodiments can be implemented with various commercially available operating systems 90 or combinations of operating systems 90.

All or a portion of the embodiments may be implemented as a computer program product stored on a transitory or non-transitory computer-usable or computer-readable storage medium, such as the computer-readable storage 88, which includes complex programming instructions, such as complex computer-readable program code, configured to cause the processing device 48 to carry out the steps described herein. Thus, the computer-readable program code can comprise software instructions for implementing the functionality of the embodiments described herein when executed on the processing device 48. The processing device 48, in conjunction with the program modules 92 in the volatile memory 84, may serve as a controller for the computing device 44 that is configured to, or adapted to, implement the functionality described herein.

The computing device 44 may also include a communications interface 94 suitable for communicating with the network 38.

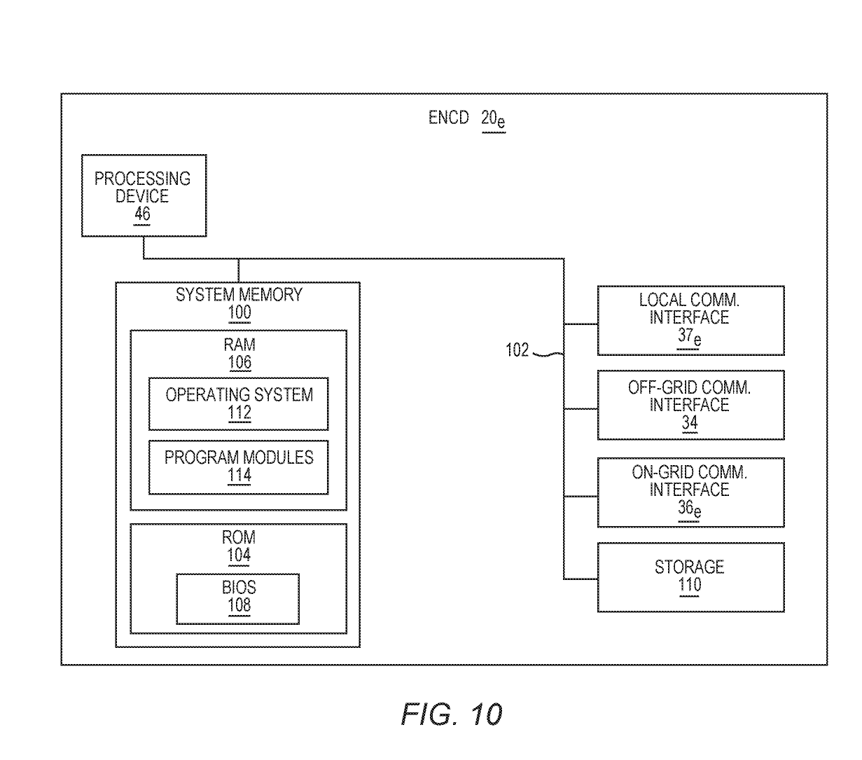

FIG. 10 is a block diagram of an ENCD 20ₑ according to one embodiment. The ENCD 20ₑ may comprise any computing or processing device capable of including firmware, hardware, and/or executing software instructions to implement the functionality described herein. In some embodiments, the ENCD 20ₑ may be a special-purpose computing device designed to implement communications power system communications as disclosed herein. The ENCD 20ₑ includes the processing device 46, a system memory 100, and a system bus 102. The system bus 102 provides an interface for system components including, but not limited to, the system memory 100 and the processing device 46. The processing device 46 can be any commercially available or proprietary processor.

The system bus 102 may be any of several types of bus structures that may further interconnect to a memory bus (with or without a memory controller), a peripheral bus, and/or a local bus using any of a variety of commercially available bus architectures. The system memory 100 may include non-volatile memory 104 (e.g., read-only memory (ROM), erasable programmable read-only memory (EPROM), electrically erasable programmable read-only memory (EEPROM), etc.) and/or volatile memory 106 (e.g., random-access memory (RAM)). A basic input/output system (BIOS) 108 may be stored in the non-volatile memory 104, and may include the basic routines that help to transfer information between elements within the ENCD 20ₑ. The volatile memory 106 may also include a high-speed RAM, such as static RAM for caching data.

The ENCD 20ₑ may further include or be coupled to a computer-readable storage 110, which may comprise, for example, an internal or external hard disk drive (HDD) (e.g., enhanced integrated drive electronics (EIDE) or serial advanced technology attachment (SATA)), HDD (e.g., EIDE or SATA) for storage, flash memory, or the like. The computer-readable storage 110 and other drives associated with computer-readable media and computer-usable media may provide non-volatile storage of data, data structures, computer-executable instructions, and the like. Although the description of computer-readable media above refers to an HDD, it should be appreciated by those skilled in the art that other types of media which are readable by a computer, such as Zip disks, magnetic cassettes, flash memory cards, cartridges, and the like, may also be used in the exemplary operating environment, and further, that any such media may contain computer-executable instructions for performing novel methods of the disclosed architecture.

A number of modules can be stored in the computer-readable storage 110 and in the volatile memory 106, including an operating system 112 and one or more program modules 114, which may implement the functionality described herein in whole or in part. It is to be appreciated that the embodiments can be implemented with various commercially available operating systems 112 or combinations of operating systems 112.

All or a portion of the embodiments may be implemented as a computer program product stored on a transitory or non-transitory computer-usable or computer-readable storage medium, such as the computer-readable storage 110, which includes complex programming instructions, such as complex computer-readable program code, configured to cause the processing device 46 to carry out the steps described herein. Thus, the computer-readable program code can comprise software instructions for implementing the functionality of the embodiments described herein when executed on the processing device 46. The processing device 46, in conjunction with the program modules 114 in the volatile memory 106, may serve as a controller for the ENCD 20ₑ that is configured to, or adapted to, implement the functionality described herein.

The ENCD 20ₑ may also include the local communications interface 37ₑ that is configured to communicate with the corresponding ECOM device 26, the off-grid communications interface 34 that is configured to communicate with the network 38, and the on-grid communications interface 36ₑ that is configured to communicate with the grid 30 of the secondary networked distribution system 14.

An INCD 20ᵢ may be configured similarly to that discussed above with respect to the ENCD 20ₑ, except the INCD 20ᵢ may not have an off-grid communications interface 34.

Those skilled in the art will recognize improvements and modifications to the preferred embodiments of the disclosure. All such improvements and modifications are considered within the scope of the concepts disclosed herein and the claims that follow.

What is claimed is:

1. A method for communicating on a secondary networked distribution system, comprising:
receiving, by a first edge node control device (ENCD) via an off-grid communications interface, a message, the first ENCD communicatively coupled to the secondary networked distribution system, the secondary networked distribution system providing electricity to a plurality of consuming endpoints; and
in response to receiving the message, retransmitting, by the first ENCD on the secondary networked distribution system, the message to a plurality of internal node control devices communicatively coupled to the secondary networked distribution system at a plurality of locations.

2. The method of claim 1, wherein the first ENCD is located at a grid node, the grid node housing an electrical control or monitoring (ECOM) device coupled to the secondary networked distribution system, and wherein the first ENCD is communicatively coupled to the ECOM device and is configured to, in response to receiving the message, send a signal to the ECOM device to cause the ECOM device to alter or monitor an electrical characteristic of the secondary networked distribution system.

3. The method of claim 2, wherein the ECOM device comprises one of a transformer, a switch, a fuse, or a monitoring device.

4. The method of claim 1, wherein receiving, by the first ENCD via the off-grid communications interface, the message, further comprises:
receiving, by a plurality of ENCDs, including the first ENCD, the message substantially concurrently; and
wherein retransmitting, by the first ENCD on the secondary networked distribution system, the message to the plurality of internal node control devices communicatively coupled to the secondary networked distribution system at the plurality of locations further comprises retransmitting, by the plurality of ENCDs on the secondary networked distribution system, the message to the plurality of internal node control devices communicatively coupled to the secondary networked distribution system at the plurality of locations.

5. The method of claim 1, further comprising determining that the plurality of internal node control devices received the message.

6. The method of claim 5, wherein determining that the plurality of internal node control devices received the message comprises receiving a plurality of acknowledgement messages via the secondary networked distribution system, each acknowledgement message being sent by one of the plurality of internal node control devices.

7. The method of claim 6, wherein determining that the plurality of internal node control devices received the message further comprises determining that a negative acknowledgement message has not been received within a predetermined timeframe.

8. The method of claim 1, further comprising receiving, by an internal node control device, the message, and retransmitting the message on the secondary networked distribution system.

9. The method of claim 1, further comprising receiving, by an internal node control device, the message, and transmitting, on the secondary distribution network system an acknowledgement message indicating the internal node control device received the message.

10. The method of claim 1, further comprising:
receiving, by an internal node control device, the message;
determining that the message is directed to the internal node control device;
determining that the message identifies an action to be performed by the internal node control device; and
performing the action.

11. The method of claim 10, further comprising:
determining that the message identifies a future time when the action is to be performed;
waiting until the future time; and
performing the action.

12. The method of claim 10, further comprising:
determining that the message identifies a future event that will trigger the action to be performed;
determining that the future event has occurred; and
performing the action.

13. The method of claim 12, wherein the future event comprises a presence of a tone on the secondary networked distribution system, and further comprising:
listening to the secondary networked distribution system for the presence of the tone;
detecting the presence of the tone on the secondary networked distribution system; and
in response to detecting the presence of the tone on the secondary networked distribution system, performing the action.

14. The method of claim 1, wherein the message is addressed to a first internal node control device of the plurality of internal node control devices and a second internal node control device of the plurality of internal node control devices, and the message identifies an action to be performed at a future time concurrently by the first internal node control device and the second internal node control device.

15. A system for communicating on a secondary networked distribution system, comprising:
an edge node control device comprising:
an on-grid communications interface configured to be communicatively coupled to the secondary networked distribution system, the secondary networked distribution system configured to provide electricity to a plurality of consuming endpoints;
an off-grid communications interface configured to communicate via an off-grid communications technology; and
a first processing device communicatively coupled to the on-grid communications interface and the off-grid communications interface, and configured to:
receive, via the off-grid communications interface, a message; and
in response to receiving the message, retransmit on the secondary networked distribution system the message to a plurality of internal node control devices communicatively coupled to the secondary networked distribution system at a plurality of locations.

16. The system of claim 15, wherein the edge node control device further comprises:
a communications interface configured to communicate with an electrical control or monitoring (ECOM) device configured to be coupled to the second networked distribution system; and
wherein the first processing device is communicatively coupled to the communications interface and is further configured to:
in response receiving the message, send a signal to the ECOM device to cause the ECOM device to alter or monitor an electrical characteristic of the secondary networked distribution system.

17. The system of claim 15 further comprising a plurality of edge node control devices, wherein each edge node control device of the plurality of edge node control devices is configured to:
receive the message substantially concurrently; and
retransmit, on the secondary networked distribution system, the message to the plurality of internal node control devices.

18. The system of claim 15, further comprising:
a computing device comprising:
a communications interface; and
a second processing device communicatively coupled to the communications interface and configured to:
generate the message;
transmit the message to the edge node control device; and
determine that the plurality of internal node control devices received the message.

19. The system of claim 18, wherein to determine that the plurality of internal node control devices received the message the second processing device is further configured to receive a plurality of acknowledgement messages via the secondary networked distribution system, each acknowledgement message being sent by one of the plurality of internal node control devices.
